(19) United States
(12) Patent Application Publication
(10) Pub. No.: US 2026/0109887 A1
(43) Pub. Date: Apr. 23, 2026

(54) ADHESIVE STRUCTURE FOR ADHERING SUBSTRATE TO BASE AND ASSOCIATED METHODS

(71) Applicant: CORNING INCORPORATED, Corning, NY (US)

(72) Inventors: Haixing Chen, Shanghai (CN); Yukai Cheng, Hefei City (CN); Qing Gao, Shanghai (CN); James Andrew West, Painted Post, NY (US); Xiwen Zhang, Shanghai (CN)

(21) Appl. No.: 19/359,141

(22) Filed: Oct. 15, 2025

(30) Foreign Application Priority Data
Oct. 18, 2024 (CN) 202411463728.8

(51) Int. Cl. C09J 7/38; B32B 7/14; B32B 17/10

(52) U.S. Cl. CPC C09J 7/385; B32B 7/14; B32B 17/10; B32B 2307/7376; C09J 2301/124; C09J 2301/204; C09J 2301/302; C09J 2400/146; C09J 2433/00

(57) ABSTRACT

An adhesive stack includes a film layer comprising a first surface and a second surface; a first adhesive layer disposed on the first surface; and a second adhesive layer disposed on the second surface. Adhesive areas defined by the first adhesive layer and the second adhesive layer do not overlap one another to prevent heat transfer through the adhesive stack between a base and substrate that are bonded to one another via the adhesive stack. As a result, a uniform temperature within the substrate can be maintained even if the substrate is exposed to a heat flux from a heat source.

### CROSS-REFERENCE TO RELATED APPLICATIONS

This application claims the benefit of priority under 35 U.S.C. § 119 of Chinese Patent Application Serial No. 202411463728.8, filed on Oct. 18, 2024, the content of which is relied upon and incorporated herein by reference in its entirety.

### FIELD

The present disclosure relates to an adhesive stack for adhering a substrate to a base in an environment in which the substrate is exposed to heat.

### BACKGROUND

In various applications, there may be situations in which a substrate (e.g., formed from a suitable glass, glass-ceramic, ceramic, or polymeric material) is placed in environment where the substrate is subjected to heating above an ambient temperature and where it is desirable to attach the substrate to a base (e.g., a fixture or structural element in a larger system). For such attachment, an adhesive may be disposed between the substrate and base to bond the substrate to the base. To save adhesive material, the adhesive may not cover the entire surface of the substrate that is bonded to the base, but instead be applied in a plurality of discrete areas. As a result, some areas of the substrate may contact the adhesive and other areas of the substrate may not contact the adhesive. Such a configuration can produce variability in how heat is transferred between the substrate and the base, resulting in different areas of the substrate being maintained at different temperatures than one another as a result of the heating. Such temperature variability may be undesirable.

Accordingly, an adhesive structure that can aid in reducing such attachment-induced temperature variability is desired.

### SUMMARY

An aspect (1) of the present disclosure pertains to an adhesive stack comprising: a film layer comprising a first surface and a second surface; a first adhesive layer disposed on the first surface; and a second adhesive layer disposed on the second surface, wherein adhesive areas defined by the first adhesive layer and the second adhesive layer do not overlap one another in a first direction perpendicular to the first surface of the film layer.

An aspect (2) of the present disclosure pertains to an adhesive stack according to the aspect (1), wherein peripheral edges of the adhesive areas defined by the first adhesive layer and the second adhesive layer are separated from one another by at least 2 mm in a second direction parallel to the first surface.

An aspect (3) of the present disclosure pertains to an adhesive stack according to the aspect (2), wherein the edges are separated from one another by at least 4 mm in the second direction.

An aspect (4) of the present disclosure pertains to an adhesive stack according to any of the aspects (1)-(3), wherein one of the first adhesive layer and the second adhesive layer comprises a single adhesive area on one of the first surface or the second surface.

An aspect (5) of the present disclosure pertains to an adhesive stack according to the aspect (1), wherein the other one of the first adhesive layer second adhesive layer comprises a plurality of discrete adhesive areas on the other one of the first surface and the second surface.

An aspect (6) of the present disclosure pertains to an adhesive stack according to the aspect (5), wherein the plurality of discrete areas are symmetrically arranged about a geometric center of the film layer.

An aspect (7) of the present disclosure pertains to an adhesive stack according to the aspect (6), wherein the single adhesive area is centered on the one of the of the first surface and the second surface.

An aspect (8) of the present disclosure pertains to an adhesive stack according to the aspect (4), wherein the discrete adhesive areas and the single adhesive area all have the same surface area.

An aspect (9) of the present disclosure pertains to an adhesive stack according to any of the aspects (1)-(3), wherein: both the first adhesive layer and the second adhesive layer define at least two adhesive areas, the first adhesive layer defines a first number of adhesive areas, the second adhesive layer defines a second number of adhesive areas different than the first number of adhesive areas.

An aspect (10) of the present disclosure pertains to an adhesive stack according to the aspect (9), wherein: one of the first adhesive layer and the second adhesive layer defines a greater number of adhesive areas and comprises a central adhesive area that is geometrically centered on the film layer, and the other of the first adhesive layer and the second adhesive layer defines a smaller number of adhesive areas and comprises adhesive areas that are symmetrically arranged around the central adhesive area in at least one direction.

An aspect (11) of the present disclosure pertains to an adhesive stack according to any of the aspects (1)-(3), wherein the film layer is formed of a thermoplastic resin.

An aspect (12) of the present disclosure pertains to an adhesive stack according to the aspect (11), wherein the thermoplastic resin is polyethylene terephthalate and wherein the film layer comprises a thickness of at least 35 mm.

An aspect (13) of the present disclosure pertains to an adhesive stack according to any of the aspects (1)-(3), wherein the first adhesive layer and the second adhesive layer are formed of an acrylic pressure-sensitive adhesive.

An aspect (14) of the present disclosure pertains to an apparatus comprising: a base comprising a base surface; a substrate comprising a first major surface and a second major surface opposite the first major surface, the first major surface facing away from the base; and an adhesive stack disposed between base and the substrate, the adhesive stack comprising: a film layer comprising a first surface and a second surface; a first adhesive layer disposed on the first surface and bonding the first surface to the second major surface; and a second adhesive layer disposed on the second surface and bonding the second surface to the base surface so that the substrate is bonded to the base via the adhesive stack, wherein: adhesive areas defined by the first adhesive layer and the second adhesive layer do not overlap one another in a first direction perpendicular to the base surface, and when the first major surface of the substrate is heated to a temperature above 50° C. from a heat source emitting a heat flux onto the first major surface, the adhesive stack does not de-bond from the base or substrate.

An aspect (15) of the present disclosure pertains to an apparatus according to the aspect (14), wherein the substrate is a glass substrate.

An aspect (16) of the present disclosure pertains to an apparatus according to the aspect (15), wherein the base is a glass plate.

An aspect (17) of the present disclosure pertains to an apparatus according to the aspect (15), wherein the adhesive stack is constructed such that the film layer does not contact the base or the substrate.

An aspect (18) of the present disclosure pertains to an apparatus according to any of the aspects (14)-(17), wherein peripheral edges of the adhesive areas defined by the first adhesive layer and the second adhesive layer are separated from one another by at least 2 mm in a second direction parallel to the fist surface.

An aspect (19) of the present disclosure pertains to an apparatus according to the aspect (18), wherein the edges are separated from one another by at least 4 mm in the second direction.

An aspect (20) of the present disclosure pertains to an apparatus according to any of the aspects (14)-(17), wherein one of the first adhesive layer and the second adhesive layer comprises a single adhesive area on one of the first surface or the second surface.

An aspect (21) of the present disclosure pertains to an apparatus according to the aspect (20), wherein the other one of the first adhesive layer second adhesive layer comprises a plurality discrete adhesive areas on the other one of the first surface and the second surface.

An aspect (22) of the present disclosure pertains to an apparatus according to the aspect (21), wherein the plurality of discrete areas are symmetrically arranged about a geometric center of the film layer.

An aspect (23) of the present disclosure pertains to an apparatus according to the aspect (22), wherein the single adhesive area is centered on the one of the of the first surface and the second surface.

An aspect (24) of the present disclosure pertains to an apparatus according to the aspect (21), wherein the discrete adhesive areas and the single adhesive area all have the same surface area.

An aspect (25) of the present disclosure pertains to an apparatus according to any of the aspects (14)-(17), wherein: both the first adhesive layer and the second adhesive layer define at least two adhesive areas, the first adhesive layer defines a first number of adhesive areas, the second adhesive layer defines a second number of adhesive areas that is different than the first number of adhesive areas.

An aspect (26) of the present disclosure pertains to an apparatus according to the aspect (25), wherein: one of the first adhesive layer and the second adhesive layer defines a greater number of adhesive areas and comprises a central adhesive area that is geometrically centered on the film layer, and the one of the first adhesive layer and the second adhesive layer defines a smaller number of adhesive areas and comprises adhesive areas that are symmetrically arranged around the central adhesive area in at least one direction.

An aspect (27) of the present disclosure pertains to an apparatus according to any of the aspects (14)-(17), wherein the film layer is formed of a thermoplastic resin.

An aspect (28) of the present disclosure pertains to an apparatus according to the aspect (27), wherein the thermoplastic resin is polyethylene terephthalate and wherein the film layer comprises a thickness of at least 35 mm.

An aspect (29) of the present disclosure pertains to an apparatus according to any of the aspects (14)-(17), wherein the first adhesive layer and the second adhesive layer are formed of an acrylic pressure-sensitive adhesive.

An aspect (30) of the present disclosure pertains to a method comprising adhering a substrate to a base using an adhesive stack of any of claims 1-3.

An aspect (31) of the present disclosure pertains to a method according to the aspect (30), further comprising removing the substrate from the base to de-bond the adhesive stack from the base by applying a mechanical force to the substrate.

It is to be understood that both the foregoing general description and the following detailed description are merely exemplary, and are intended to provide an overview or framework to understanding the nature and character of the claims. The accompanying drawings are comprised to provide a further understanding, and are incorporated in and constitute a part of this specification. The drawings illustrate one or more embodiment(s), and together with the description serve to explain principles and operation of the various aspects.

### BRIEF DESCRIPTION OF THE DRAWINGS

The accompanying drawings incorporated in and forming a part of the specification illustrate several aspects of the present invention and, together with the description, explain the principles of the invention. In the drawings:

FIG. 1 depicts a side view of an apparatus comprising a substrate exposed to heat flux from a heat source, with the substrate being bonded to a base via an adhesive stack, according to one or more embodiments of the present disclosure;

FIG. 2A depicts a side view of an adhesive stack used to adhere the substrate to the base depicted in FIG. 1, according to one or more embodiments of the present disclosure;

FIG. 2B depicts a top-down schematic view of adhesive areas defined by first and second adhesive layers of the adhesive stack depicted in FIG. 2A, according to one or more embodiments of the present disclosure;

FIG. 3A depicts a side view of an adhesive stack used to adhere the substrate to the base depicted in FIG. 1, according to one or more embodiments of the present disclosure;

FIG. 3B depicts a top-down schematic view of adhesive areas defined by first and second adhesive layers of the adhesive stack depicted in FIG. 3A, according to one or more embodiments of the present disclosure;

FIG. 4A depicts a side view of an adhesive stack used to adhere the substrate to the base depicted in FIG. 1, according to one or more embodiments of the present disclosure;

FIG. 4B depicts a top-down schematic view of adhesive areas defined by first and second adhesive layers of the adhesive stack depicted in FIG. 4A, according to one or more embodiments of the present disclosure; and

FIG. 5 depicts a side view of an adhesive stack used to adhere the substrate to the base depicted in FIG. 1, according to one or more embodiments of the present disclosure.

### DETAILED DESCRIPTION

Referring generally to the figures, described herein are adhesive stacks for adhering a substrate to a base. The adhesive stacks are configured to ameliorate non-uniformities in a temperature distribution of a substrate when a side of the substrate opposite the base is exposed to heat flux from a heat source. The adhesive stacks of the present disclosure comprise a film layer, a first adhesive layer on a first surface of the film layer, and a second adhesive layer on a second surface of the film layer. The second adhesive layer may bond the film layer to the base and the first adhesive layer may bond the film layer to the substrate. It has been found that eliminating overlap between adhesive areas defined by the first adhesive layer and the second adhesive layer in a direction normal to the base and/or first surface eliminates a direct path for heat conduction between the substrate and the base. As a result, heat transfer between areas of the substrate overlapping the adhesive stack and the base is reduced as compared to structures including adhesive stacks with overlapping opposing adhesive areas. The adhesive stacks described herein beneficially enable a relatively uniform temperature distribution to be maintained throughout substrate even when a non-uniform distribution of adhesive stacks is used to adhere the substrate to the base. The adhesive stacks described herein therefore facilitate flexibility in adhesive placement when it is desired to adhere the substrate to a base.

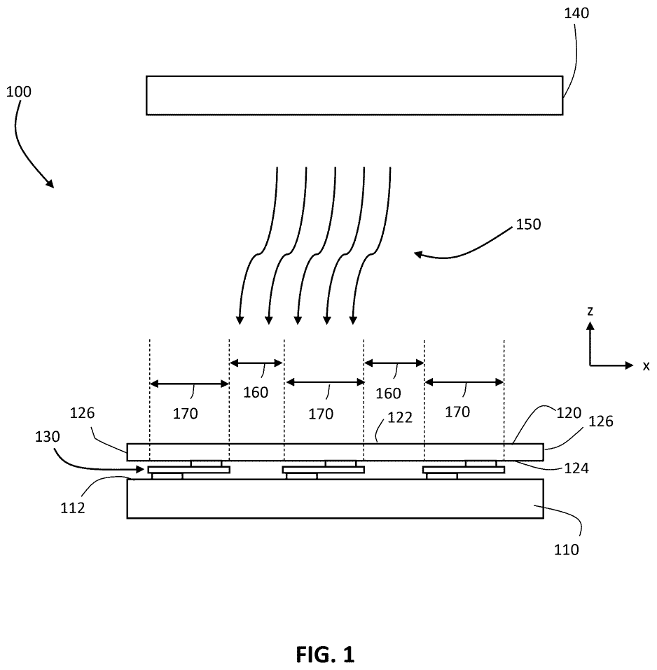

Referring now to FIG. 1, an apparatus 100 is shown. The apparatus 100 includes a base 110 including a base surface 112, a substrate 120 including a first major surface 122 and a second major surface 124 opposite the first major surface 122, and a plurality of adhesive stacks 130 disposed between base 110 and the substrate 120. The plurality of adhesive stacks 130 bond the substrate 120 to the base 110. In aspects, the bond formed between the substrate 120 and base 110 by the plurality of adhesive stacks 130 may be temporary in that the substrate 120 can be removed from the base 110 (e.g., to de-bond the at least one of the plurality of adhesive stacks 130 from the base 110 or substrate 120) by applying a mechanical force to the substrate 120, such that the substrate 120 can be removed from the base 110 without damaging (e.g., cracking, scratching, chipping) either the base 110 and the substrate 120. The apparatus 100 may represent any environment in which it is desired to adhere a substrate 120 formed of any of the materials described herein to the base 110, which may be stationary in the apparatus 100 (e.g., attached to a fixture in the building in which the apparatus 100 is situated). For example, the base 110 may be affixed to a station in a manufacturing facility and the substrate 120 may be adhered to the base to have a coating or surface treatment applied to the first major surface 122.

In the depicted example, the plurality of adhesive stacks 130 bond the second major surface 124 of the substrate 120 to the base surface 112 of the base 110. As a result, the first major surface 122 faces away from the base 110 and generally faces a heat source 140. Heat flux 150 from the heat source 140 may be incident on the first major surface 122. The form of the heat source 140, and therefore the form of the heat flux 150, can vary depending on the implementation of the apparatus 100. For example, in aspects, the heat source 140 can include a radiation emitter that emits heat flux in the form of radiation that is absorbed by the material of the substrate 120. In aspects, the heat source 140 can include a particle source and the heat flux 150 can be particles travelling towards the substrate 120. Such particles may have kinetic energy that is transferred to the substrate 120, resulting in heating, or may condense on the first major surface 122, thereby causing heating of the substrate 120. Heat flux 150 may also include energetic plasma that heats the substrate 120. Any heat source capable of raising the temperature of the substrate 120 from an ambient temperature of the apparatus 100 (e.g., 23° C.) can be used.

The substrate 120 can be any suitable material of any suitable size. In aspects, the substrate 120 may be formed of a glass, glass-ceramic, ceramic, or polymeric material. For example, in aspects, the substrate 120 is formed of a glass of a suitable composition. In aspects, the substrate 120 is a glass substrate or a glass-ceramic substrate. In aspects, the substrate 120 is a multi-component glass composition having about 40 mol % to 80 mol % silica and a balance of one or more other constituents, e.g., alumina, calcium oxide, sodium oxide, boron oxide, etc. In some implementations, the bulk composition of the substrate 120 is selected from the group consisting of aluminosilicate glass, a borosilicate glass, and a phosphosilicate glass. In other implementations, the bulk composition of the substrate 120 is selected from the group consisting of aluminosilicate glass, a borosilicate glass, a phosphosilicate glass, a soda lime glass, an alkali aluminosilicate glass, and an alkali aluminoborosilicate glass. In further implementations, the substrate 120 is a glass-based substrate, including, but not limited to, glass-ceramic materials that comprise a glass component at about 90% or greater by weight and a ceramic component.

In aspects, the substrate 120 has a bulk composition that comprises, consists essentially of or consists of a glass composition, such as Corning® Eagle XG® glass, Corning® Gorilla® glass, Corning® Gorilla® Glass 2, Corning® Gorilla® Glass 3, Corning® Gorilla® Glass 4, or Corning® Gorilla® Glass 5. In aspects, the substrate 120 has an ion-exchangeable glass composition that is strengthened by either chemical or thermal means that are known in the art. In aspects, the substrate 120 is chemically strengthened by ion exchange.

In aspects, the base 110 is formed of a material suitable for a given application. In aspects, for example, the base 110 may be formed of a material exhibiting similar properties as the material forming the substrate (e.g., if the substrate 120 is formed of glass, the base 110 may also be formed of a glass exhibiting similar properties). Such a construction may be beneficial in that the substrate 120 and base 110 may have similar coefficients of thermal expansion, which may limit thermal expansion/contraction-induced stresses on the adhesive stack 130 and lower the probability of unintended delamination. Such a construction is also beneficial in that similar adhesives may be used for each of the adhesive layers of the plurality of adhesive stacks 130, which may simplify fabrication of the plurality of adhesive stacks 130.

In the depicted example, the substrate 120 is in the form of a planar sheet with a peripheral shape defined by a plurality of minor surfaces 126. The base surface 112 is also planar and, as a result, the base surface 112 extends parallel to the first major surface 122 and the second major surface 124 (in the x-y directions of the coordinate axes in the Figures). Such a correspondence in shape between the base 110 and the substrate 120 can be beneficial in that bending stresses in the substrate 120 can be reduced. Moreover, retaining the first major surface 122 in a flat, planar shape (e.g., in a form from a material production process used to fabricate sheets of the material of the substrate 120, such as a fusion draw process in the case of a glass substrate) can facilitate performance of various processes on the first major surface 122 while the substrate 120 is adhered to the base 110. The adhesive stacks described herein are not limited to such a configuration. For example, at least one of the base surface 112, first major surface 122, or second major surface 124 may be curved. Moreover, the base surface 112 may not have the same shape as the second major surface 124 in some aspects, and the substrate 120 may be elastically bent and held in such a bent state in conformance with the base surface 112 via the plurality of adhesive stacks 130.

Referring still to FIG. 1, the plurality of adhesive stacks 130 can bond discrete areas of the second major surface 124 to the base surface 112. Limiting the extent of adhesive material used to bond the substrate 120 to the base 110 beneficially lowers adhesive material utilization. As such, the substrate includes adhered areas 170 of the first major surface 122 that overlap one of the plurality of adhesive stacks 130 in a direction perpendicular to the first major surface 122 (the z-direction in the depicted coordinate axes) and non-adhered areas 160 that do not overlap one of the plurality of adhesive stacks 130. Such non-uniform structures between the substrate 120 and base 110 can result in non-uniform heat transfer between the base 110 and substrate 120.

As a result of the heat flux 150, the first major surface 122 may be heated to temperatures above that of the base 110. Since the substrate 120 covers the portion of the base 110 that the substrate 120 is adhered to, the base 110 may not be directly exposed to the heat flux 150. Given this, the plurality of adhesive stacks 130 can serve as a conduit for heat transfer as the thermal system of including the base 110 and substrate 120 equilibrates. It has been found that heat conduction through the plurality of adhesive stacks 130 can result in a greater amount of heat transfer at the adhered areas 170 than the non-adhered areas 160. Particularly, it has been that continuous paths of solid material (formed of components of the adhesive stacks) in the z-direction extending between the base 110 and substrate 120 facilitate such conduction. When such continuous paths of solid material are present, a non-uniform temperature distribution on the first major surface 122 can arise, with the adhered areas 170 having a lower temperature than the non-adhered areas 160 by a considerable amount (e.g., more than 10° C. when the first major surface 122 is heated to temperatures of more than 50° C.), which can create difficulties in various applications. In view of the foregoing, the plurality of adhesive stacks 130 have been constructed to eliminate direct paths for conductive heat transfer between the base 110 and the substrate 120.

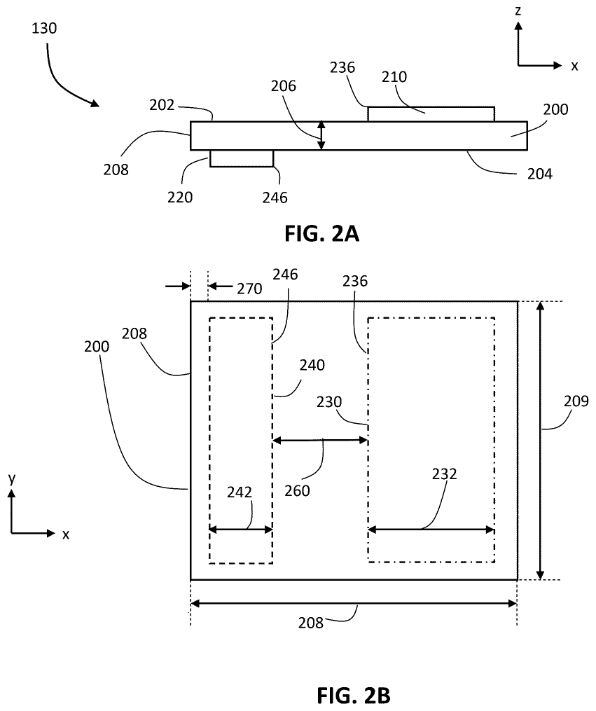

FIG. 2A depicts a side view of one of the plurality of adhesive stacks 130, according to one or more embodiments of the present disclosure. As shown, the adhesive stack 130 includes a film layer 200 including a first surface 202 and a second surface 204, a first adhesive layer 210 disposed on the first surface 202, and a second adhesive layer 220 disposed on the second surface 204. The film layer 200 may be a pre-formed layer and the first and second adhesive layers 210 and 220 may be formed of sections of adhesive that are coated onto the film layer. 200. The film layer 200 is constructed of a suitable material based on various properties (e.g., flexibility, tensile strength, temperature resistance, chemical resistance, moisture resistance, dimensional stability) depending on the application. In aspects, the film layer 200 is formed of a suitable thermoplastic resin material such as polyethylene terephthalate or epoxy. Polyethylene terephthalate has been found to be suitable for various applications when the substrate 120 is a glass substrate, exhibiting suitable flexibility, dimensional stability, and durability for various high temperature applications. In other aspects, the film layer 200 is formed of another polymeric material such as a polyimide film or a rubber. In aspects, the film layer 200 comprises a metallized foil layer. The film layer 200 comprises a thickness 206. In aspects, the thickness 206 of at least 35 mm to prevent the substrate 120 from directly contacting the base 110. For example, in aspects, the thickness 206 can range from 30 mm to 100 mm (e.g., from 35 mm to 70 mm, from 40 mm to 60 mm, or from 48 mm to 52 mm). The film layer 200 can also have a suitable length 207 in the x-direction and a suitable width 209 in the y-direction. In aspects, the length 207 and the width 209 are determined based on the size of the substrate 120 being bonded (see FIG. 1) and the number of adhesive stacks being used in the bonding.

In aspects, the first adhesive layer 210 and the second adhesive layer 220 can include at least one of a toughened epoxy, a flexible epoxy, an acrylic, a silicone, a urethane, a polyurethane, or a silane modified polymer. It has been found that using an acrylic adhesive is beneficial for providing a strong initial tack strength, facilitating quick bonding with both the base 110 and substrate 120 with minimal initial pressure. Acrylic adhesives are also favorably stable over a wide range of temperatures. The first and second adhesive layers 210 and 220 may have any suitable thickness to ensure adequate bonding between the base 110 and substrate 120. For example, in aspects, the thicknesses of the first and second adhesive layers 210 can range from 0.1 mm to 5 mm or from 0.5 mm to 2 mm.

FIG. 2B schematically depicts the positioning of the first and second adhesive layers 210 and 220 on the film layer 200. As shown, the first adhesive layer 210 defines a first adhesive area 230 and the second adhesive layer 220 defines a second adhesive area 240. The first adhesive area 230 represents an area of the first surface 202 (see FIG. 2A) over which the adhesive making up the first adhesive layer 210 is disposed. The first adhesive area 230 may represent a surface area of adhesive that may bond to the second major surface 124 of the substrate 120 (see FIG. 1). The second adhesive area 240 represents an area of the second surface 204 (see FIG. 2A) over which the adhesive making up the second adhesive layer 220 is disposed. The second adhesive area 240 may represent a surface area of adhesive that may bond to the base surface 112 (see FIG. 1).

As shown in FIGS. 2A and 2B, the first and second adhesive layers 210 and 220 are formed so that the first and second adhesive areas 230 and 240 defined thereby do not overlap one another in the z-direction (which extends perpendicular to the first surface 202). That is, if a line extending in the z-direction were scanned over an entirety of the surface area of the first surface 202, no single line would pass through both the first adhesive area 230 and the second adhesive area 240. As shown in FIG. 2B, an entirety of the first adhesive area 230 is offset from the second adhesive area 240 in the x-direction (which extends parallel to the first surface 202), such that an edge 236 of the first adhesive area 230 most proximate to a geometric center of the film layer 200 and an edge 246 of the second adhesive area 240 most proximate to the geometric center are separated from one another by a separation distance 260 in the x-direction. In aspects, the separation distance 260 is at least 2 mm, or preferably at least 4 mm, to facilitate preventing heat conduction through the adhesive stack 130. For example, the separation distance 260 can be 2 mm, 3 mm, 4 mm, 5 mm, 6 mm, 7 mm, 8 mm, 9 mm, 10 mm, or anywhere in a range bounded by any two of such values. In aspects, he separation distance 260 represents a minimum edge-to-edge separation distance that separates adhesive areas formed by the first adhesive layer 210 and the second adhesive layer 220 in a plane parallel to the first surface 202 and/or base surface 112 (see FIG. 1A). The extent of the offsetting between the first and second adhesive areas 230 and 240 ensures there is no direct conduction path in the z-direction through material of the adhesive stack 130 between the substrate 120 and the base 110 (see FIG. 1), which has been found to aid in reducing non-uniformities in the temperature of the first major surface 122 despite the heat flux 150.

In the depicted example, the first adhesive area 230 is larger than the second adhesive area 240. The first adhesive area 230 being larger may prevent contact between the substrate 120 and film layer 200. The first adhesive area 230 being larger may also facilitate bonding to the substrate 120 and removal of the substrate 120 from the base 110 by peeling the second adhesive layer 220 from the base 110. As shown in FIG. 2B, the first adhesive area 230 has a first dimension 232 in the x-direction and the second adhesive area 240 has a second dimension 242 in the x-direction. In aspects, the first dimension 232 is at least two times larger than the second dimension 242.

In aspects, the first and second adhesive areas 230 and 240 can have the same dimensions in the y-direction to distribute adhesion over a wide enough area for adequate bonding. The first and second adhesive areas 230 and 240 may have different peripheral shapes in certain embodiments. In aspects, the first and second adhesive areas 230 and 240 are separated from a peripheral edge 208 of the film layer 200 by at least a minimum edge separation distance 270. In aspects the minimum edge separation distance 270 is 0.5 mm to facilitate manufacturing the adhesive stack 130.

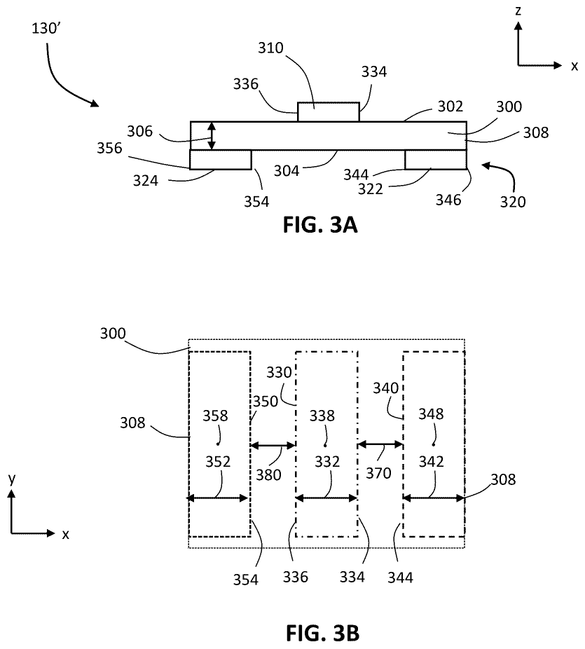

Referring now to FIGS. 3A and 3B, another adhesive stack 130′ is schematically depicted. The adhesive stack 130′ can be used in place of some or all of the plurality of adhesive stacks 130 depicted in FIG. 1. As shown, the adhesive stack 130′ includes a film layer 300 including a first surface 302 and a second surface 304, a first adhesive layer 310 disposed on the first surface 302, and a second adhesive layer 320 disposed on the second surface 304. The film layer 300 may be a pre-formed layer and the first and second adhesive layers 310 and 320 may be formed of sections of material that are coated onto the film layer 300. The materials and thickness of the film layer 300, first adhesive layer 310, and second adhesive layer 320 may be similar to those described above with respect to the film layer 200, first adhesive layer 210, and second adhesive layer 220.

The adhesive stack 130′ differs from the adhesive stack 130 described with respect to FIGS. 2A and 2B in that the second adhesive layer 320 includes a plurality of discrete adhesive areas disposed around an adhesive area formed by the first adhesive layer 310. The plurality of discrete adhesive areas formed by the second adhesive layer 320 has been found to aid in preventing contact between the base 110 and the film layer 300, which has been found to increase conductive heat transfer. As shown in FIG. 3B, the first adhesive layer 310 defines a first adhesive area 330 and the second adhesive layer 320 defines a second adhesive area 340 and a third adhesive area 350. The second adhesive area 340 is offset from the first adhesive area 330 in the x-direction and the third adhesive area 350 is offset from the first adhesive area 330 in the negative x-direction. As shown, edges 334 and 344 of the first adhesive area 330 and the second adhesive area 340 that are most proximate to one another are separated from one another by a separation distance 370 in the x-direction. Edges 336 and 354 of the first adhesive area 330 and the third adhesive area 350 that are most proximal to one another are separated from one another by a separation distance 380 in the x-direction. In aspects the separation distances 370 and 380 can be 2 mm, 3 mm, 4 mm, 5 mm, 6 mm, 7 mm, 8 mm, 9 mm, 10 mm, or anywhere in a range bounded by any two of such values. The extent of the offsetting from the first adhesive area 330 to the second and third adhesives areas 340 and 350 ensures there is no direct conduction path in the z-direction through material of the adhesive stack 130 between the substrate 120 and the base 110 (see FIG. 1), which has been found to aid in reducing non-uniformities in the temperature of the first major surface 122 despite the heat flux 150. There is no overlap between the first adhesive area 330 and either of the second and third adhesive areas 340 and 350 in the z-direction. While the second adhesive layer 320 is depicted to include two adhesive areas, it should be understood that any suitable number of discrete adhesive areas can be included, so long as none of the discrete adhesive areas overlap with the first adhesive area 330 in the z-direction.

In aspects, the plurality of discrete adhesive areas formed in the second adhesive layer 320 are symmetrically arranged about a geometric center of the second surface 304 in at least one direction. As shown in FIG. 3, for example, the edges 344 and 354 of the second and third adhesive areas 340 and 350 are equidistant from a geometric center of the second surface 304 in the x-direction, and the second and third adhesive areas 340 and 350 have equal dimensions in the x and y-directions. As a result, a geometric center 338 of the first adhesive area 330 is disposed on a line connecting geometric centers 348 and 358 of the second and third adhesive areas 348 and 358, with the geometric center 338 being equidistant from the geometric centers 348 and 358. An arrangement of adhesive areas is symmetrical herein if the geometric centers of each adhesive area is arranged equidistant from a center of the surface on which the adhesive layer defining the adhesive areas is formed.

In aspects, the second adhesive area 340 and the third adhesive area 350 may also form a combined adhesive area that is symmetrical about at least one axis of symmetry extending through a point overlapping a geometric center of the second surface 304. For example, the depicted second adhesive area 340 and third adhesive area 350 form a combined adhesive area that is symmetrical about a first axis of symmetry extending in the x-direction and a second axis of symmetry extending in the y-direction, with both the first and second axes of symmetry extending through a point overlapping the geometric center of the second surface 304 in the z-direction. Such a symmetrical adhesive area is believed to aid in preventing contact between the film layer 300 and the base 110 (see FIG. 1). Preventing such contact prevents heat transfer between the substrate 120 and base 110 and aids in maintaining temperature uniformity of the first major surface 122 when exposed to the heat flux 150.

In aspects, the first adhesive area 330 is geometrically centered on the first surface 302. That is, a geometric center of the first adhesive layer 310 may overlap the geometric center of the first surface 302 in the x-y plane. The first adhesive area 330 may also be symmetrical about axes of symmetry extending in both the x-direction and y-direction, with such axes extending through the geometric center thereof. Such an arrangement has been found to aid in preventing contact between the film layer 300 and the substrate 120 (see FIG. 1). Preventing such contact prevents heat transfer between the substrate 120 and base 110 and aids in maintaining temperature uniformity of the first major surface 122 when exposed to the heat flux 150.

In aspects, outer edges 346 and 356 of the second adhesive area 340 and the third adhesive area 350 are aligned with outer edges 308 of the film layer 300 in the z-direction (e.g., one of the outer edges 308 of the film layer 300 and the outer edge 346 of the second adhesive area 340 may form a straight line in some aspects). Such a configuration may maximize the area of the second surface 304 over which the second adhesive layer 320 may be disposed to maximize bonding area between the film layer 300 and base 110 (see FIG. 1).

In aspects, each of the first adhesive area 330, the second adhesive area 340, and the third adhesive area 350 have the same dimensions in at least one the x and y-directions. For example, the first adhesive area 330 is depicted to have a first dimension 332 in the x-direction, the second adhesive area 340 is depicted to have a second dimension 342 in the x-direction, and the third adhesive area 350 is depicted to have a third dimension 352 in the x-direction. In aspects, the first, second, and third dimensions 332, 342, and 352 can equal one another to facilitate forming symmetrical adhesive areas and to aid in fabricating the adhesive stack 130′. In aspects, the dimensions of the first adhesive area 330, the second adhesive area 340, and the third adhesive area 350 differ from one another in at least one the x and y-directions. While the depicted symmetrical adhesive areas may ensure a lack of contact between the film layer 300, base 110, and substrate 120 (see FIG. 1), asymmetrical arrangements may also function so long as overlap between adhesive areas is avoided.

In the aspect depicted in FIGS. 3A and 3B, the first adhesive layer 310 may have a combined adhesive area (corresponding to the first adhesive area 330) that is less than a combined adhesive area (corresponding to a combination of the second adhesive area 340 and the third adhesive area 350) of the second adhesive layer 320. Indeed, the first adhesive area 330 is half the combination of the second and third adhesive areas 340 and 350 in the depicted embodiment. Such a configuration facilitates removal of the substrate 120 from the base 110 at the first adhesive layer 310 by applying a mechanical force to the substrate 120. Moreover the reduced bonding area between the adhesive stack 130′ and the substrate 120 may reduce heat transfer to the film layer 300 as compared to that caused by the embodiment depicted in FIGS. 2A and 2B.

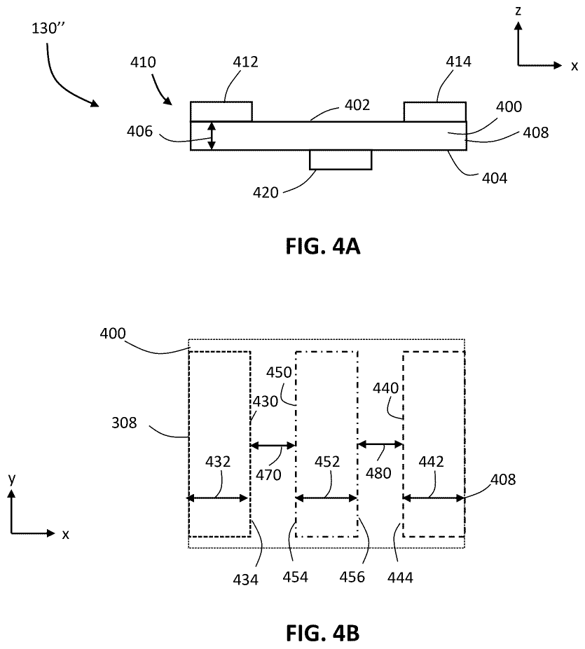

Referring now to FIGS. 4A and 4B, another adhesive stack 130″ is schematically depicted. The adhesive stack 130″ can be used in place of some or all of the plurality of adhesive stacks 130 depicted in FIG. 1. As shown, the adhesive stack 130″ includes a film layer 400 including a first surface 402 and a second surface 404, a first adhesive layer 410 disposed on the first surface 402, and a second adhesive layer 420 disposed on the second surface 404. The film layer 400 may be a pre-formed layer and the first and second adhesive layers 410 and 420 may be formed of sections of material that are coated onto the film layer 400. The materials and thickness of the film layer 400, first adhesive layer 410, and second adhesive layer 420 may be similar to those described above with respect to the film layer 200, first adhesive layer 210, and second adhesive layer 220.

The adhesive stack 130″ differs from the adhesive stack 130 described with respect to FIGS. 2A and 2B in that the first adhesive layer 410 includes a plurality of discrete adhesive areas disposed around an adhesive area formed by the second adhesive layer 420. The plurality of discrete adhesive areas formed by the first adhesive layer 410 has been found to aid in preventing contact between the substrate 120 and the film layer 400, which has been found to increase conductive heat transfer. As shown in FIG. 4B, the first adhesive layer 40 defines a first adhesive area 430 and a second adhesive area 440, while the second adhesive layer 320 defines a third adhesive area 450. The first adhesive area 430 is offset from the third adhesive area 450 in the x-direction and the second adhesive area 440 is offset from the third adhesive area 450 in the negative x-direction. As shown, edges 434 and 454 of the first adhesive area 430 and the third adhesive area 450 that are most proximate to one another are separated from one another by a separation distance 470 in the x-direction. Edges 444 and 456 of the second adhesive area 440 and the third adhesive area 450 that are most proximal to one another are separated from one another by a separation distance 480 in the x-direction. In aspects the separation distances 470 and 480 can be 2 mm, 3 mm, 4 mm, 5 mm, 6 mm, 7 mm, 8 mm, 9 mm, 10 mm, or anywhere in a range bounded by any two of such values. The extent of the offsetting from the third adhesive area 450 to the first and second adhesives areas 430 and 440 ensures there is no direct conduction path in the z-direction through material of the adhesive stack 130 between the substrate 120 and the base 110 (see FIG. 1), which has been found to aid in reducing non-uniformities in the temperature of the first major surface 122 despite the heat flux 150. There is no overlap between the third adhesive area 450 and either of the first and second adhesive areas 430 and 440 in the z-direction.

In aspects, the plurality of discrete adhesive areas formed in the first adhesive layer 410 are symmetrically arranged about a geometric center of the first surface 402 in at least one direction. As shown in FIG. 3, for example, the edges 434 and 444 of the first and second adhesive areas 430 and 440 are equidistant from a geometric center of the first surface 402, and the first and second adhesive areas 430 and 440 have equal dimensions in the x and y-directions. In aspects, the first adhesive area 430 and the second adhesive area 440 may also form a combined adhesive area that is symmetrical about at least one axis of symmetry extending through a point overlapping a geometric center of the first surface 402. Such a symmetrical adhesive area is believed to aid in preventing contact between the film layer 400 and the substrate 120 (see FIG. 1). The third adhesive area 450 can also be centered on the second surface 404 to prevent contact between the film layer 400 and the base 110. Preventing such contact prevents heat transfer between the substrate 120 and base 110 and aids in maintaining temperature uniformity of the first major surface 122 when exposed to the heat flux 150. In aspects, the first, second, and third adhesives areas 430, 440, and 450 have first dimensions 432, 442, and 452 that may be similar to the first dimensions 332, 342, and 352 of the first, second, and third adhesive areas 330, 340, and 350 of the adhesive stack 130′ described with respect to FIGS. 4A and 4B.

In aspects, outer edges of the first adhesive area 430 and the second adhesive area 440 are aligned with outer edges 408 of the film layer 400 in the z-direction to maximize the area of the first surface 402 over which the first adhesive layer 410 may be disposed to maximize bonding area between the film layer 400 and substrate 120 (see FIG. 1).

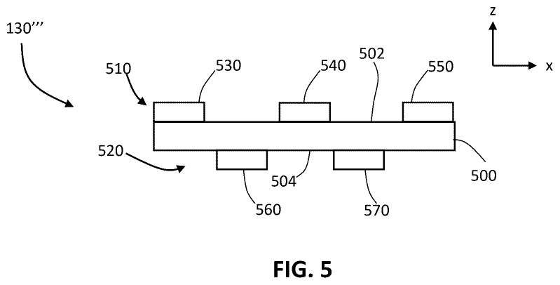

Referring now to FIG. 5, aspects including an adhesive stack where both the first adhesive layer and the second adhesive layer define at least two adhesive areas are also envisioned. In such aspects, the adhesive layers may define any number of adhesive areas, so long as none of the adhesive areas overlap one another in a direction extending perpendicular to the base surface 112 (see FIG. 1A) or adhesive layer. In aspects, the first and second adhesive layers can define different numbers of adhesive areas; and the one of the first adhesive layer and the second adhesive layer defining a greater number of adhesive areas can comprise a central adhesive area that is geometrically centered on the film layer. In such aspects, the one of the first adhesive layer and the second adhesive layer defining a smaller number of adhesive areas can comprise adhesive areas that are symmetrically arranged around the central adhesive area in at least one direction.

FIG. 5 schematically depicts an adhesive stack 130′″ that can be used in place of some or all of the plurality of adhesive stacks 130 depicted in FIG. 1. As shown, the adhesive stack 130′″ includes a film layer 500 including a first surface 502 and a second surface 504, a first adhesive layer 510 disposed on the first surface 502, and a second adhesive layer 520 disposed on the second surface 504. The film layer 500 may be a pre-formed layer and the first and second adhesive layers 510 and 520 may be formed of sections of material that are coated onto the film layer 500. The materials and thickness of the film layer 500, first adhesive layer 510, and second adhesive layer 520 may be similar to those described above with respect to the film layer 200, first adhesive layer 210, and second adhesive layer 220.

In the depicted example, the first adhesive layer 510 defines a greater number of adhesive areas than the second adhesive layer 520. The second adhesive layer 520 can define n adhesive areas and the first adhesive layer 510 can define n+1 adhesive areas. As shown, the first adhesive layer 510 defines a first adhesive area 530, a second adhesive area 540, and a third adhesive area 550; while the second adhesive layer 520 defines a fourth adhesive area 560 and a fifth adhesive area 570. The fourth and fifth adhesive areas 560 and 570 are offset from the first, second, and third adhesive areas 530, 540, and 550 and the x-direction, so that none of the adhesive areas defined by the first adhesive layer 510 overlaps any of the adhesive areas defined by the second adhesive layer 520 in the z-direction. In an embodiment, the adhesive areas 530, 540, 550, 560, and 570 can have any shape and offset in directions parallel to the first and second surfaces 502 and 504. For example, each of the adhesive areas 530, 540, 550, 560, and 570 can be rectangular strips with lengthwise dimensions in the y-direction, as described above with respect to FIGS. 3B and 4B. Edges of the first and second adhesive areas 530 and 540 that are most proximate to the fourth adhesive area 560 can be offset from the fourth adhesive 560 in the x-direction by at least 2 mm to prevent heat transfer. Edges of the second and third adhesive areas 540 and 550 that are most proximate to the fifth adhesive area 570 can be offset from the fifth adhesive 570 in the x-direction by at least 2 mm to prevent heat transfer.

In the example shown in FIG. 5, the one of the first and second adhesive layers 510 and 520 that defines a greater number of adhesive areas (the first adhesive layer 510 in this example) includes a central adhesive area (the second adhesive area 540) that is geometrically centered on the film layer 500 (the second adhesive area 540 is geometrically centered on the first film surface 520 in the depicted example), while the one the one of the first adhesive layer 510 and the second adhesive layer 520 defining a smaller number of adhesive areas (the second adhesive layer 520 in the depicted example) comprises adhesive areas that are symmetrically arranged around the central adhesive area in at least one direction (the fourth and fifth adhesive areas 560 and 570 are symmetrically arranged about the second adhesive area 540 in the depicted example). As described herein, centering an adhesive area on the film layer and symmetrically arranging adhesive areas on the other side of the film layer around the centered adhesive area can aid in preventing any contact between the film layer and any of the adherends, thereby preventing heat conduction.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, “a” is intended to comprise one or more than one component or element and is not intended to be construed as meaning only one.

It will be apparent to those skilled in the art that various modifications and variations can be made without departing from the spirit or scope of the disclosed aspects. Since modifications, combinations, sub-combinations and variations of the disclosed aspects incorporating the spirit and substance of the aspects may occur to persons skilled in the art, the disclosed aspects should be construed to comprise everything within the scope of the appended claims and their equivalents.

What is claimed is:

1. An adhesive stack comprising:
a film layer comprising a first surface and a second surface;
a first adhesive layer disposed on the first surface; and
a second adhesive layer disposed on the second surface, wherein adhesive areas defined by the first adhesive layer and the second adhesive layer do not overlap one another in a first direction perpendicular to the first surface of the film layer.

2. The adhesive stack of claim 1, wherein peripheral edges of the adhesive areas defined by the first adhesive layer and the second adhesive layer are separated from one another by at least 2 mm in a second direction parallel to the first surface.

3. The adhesive stack of claim 2, wherein the peripheral edges are separated from one another by at least 4 mm in the second direction.

4. The adhesive stack of claim 1, wherein one of the first adhesive layer and the second adhesive layer comprises a single adhesive area on one of the first surface or the second surface, and wherein the other one of the first adhesive layer and the second adhesive layer comprises a plurality of discrete adhesive areas on the other one of the first surface and the second surface.

5. The adhesive stack of claim 4, wherein the plurality of discrete areas are symmetrically arranged about a geometric center of the film layer, and wherein the single adhesive area is centered on the one of the of the first surface and the second surface.

6. The adhesive stack of claim 4, wherein the discrete adhesive areas and the single adhesive area all have the same surface area.

7. The adhesive stack of claim 1, wherein:
both the first adhesive layer and the second adhesive layer define at least two adhesive areas,
the first adhesive layer defines a first number of adhesive areas,
the second adhesive layer defines a second number of adhesive areas different than the first number of adhesive areas.

8. The adhesive stack of claim 7, wherein:
one of the first adhesive layer and the second adhesive layer defines a greater number of adhesive areas and comprises a central adhesive area that is geometrically centered on the film layer, and
the other of the first adhesive layer and the second adhesive layer defines a smaller number of adhesive areas and comprises adhesive areas that are symmetrically arranged around the central adhesive area in at least one direction.

9. The adhesive stack of claim 1, wherein one or more of:
the film layer is formed of a thermoplastic resin and comprises a thickness of at least 35 mm, and
the first adhesive layer and the second adhesive layer are formed of an acrylic pressure-sensitive adhesive.

10. An apparatus comprising:
a base comprising a base surface;
a substrate comprising a first major surface and a second major surface opposite the first major surface, the first major surface facing away from the base; and
an adhesive stack disposed between base and the substrate, the adhesive stack comprising:
a film layer comprising a first surface and a second surface;
a first adhesive layer disposed on the first surface and bonding the first surface to the second major surface; and
a second adhesive layer disposed on the second surface and bonding the second surface to the base surface so that the substrate is bonded to the base via the adhesive stack, wherein:
adhesive areas defined by the first adhesive layer and the second adhesive layer do not overlap one another in a first direction perpendicular to the base surface, and
when the first major surface of the substrate is heated to a temperature above 50°C. from a heat source emitting a heat flux onto the first major surface, the adhesive stack does not de-bond from the base or substrate.

11. The apparatus of claim 10, wherein the substrate is a glass substrate.

12. The apparatus of claim 11, wherein one or more of:
the base is a glass plate, and
the adhesive stack is constructed such that the film layer does not contact the base or the substrate.

13. The apparatus of claim 10, wherein peripheral edges of the adhesive areas defined by the first adhesive layer and the second adhesive layer are separated from one another by at least 2 mm in a second direction parallel to the fist surface.

14. The apparatus of claim 13, wherein the peripheral edges are separated from one another by at least 4 mm in the second direction.

15. The apparatus of claim 10, wherein one of the first adhesive layer and the second adhesive layer comprises a single adhesive area on one of the first surface or the second surface, and wherein the other one of the first adhesive layer and second adhesive layer comprises a plurality discrete adhesive areas on the other one of the first surface and the second surface.

16. The apparatus of claim 15, wherein the plurality of discrete areas are symmetrically arranged about a geometric center of the film layer, and wherein the single adhesive area is centered on the one of the of the first surface and the second surface.

17. The apparatus of claim 15, wherein the discrete adhesive areas and the single adhesive area all have the same surface area.

18. The apparatus of claim 10, wherein:
both the first adhesive layer and the second adhesive layer define at least two adhesive areas,
the first adhesive layer defines a first number of adhesive areas,
the second adhesive layer defines a second number of adhesive areas that is different than the first number of adhesive areas.

19. The apparatus of claim 18, wherein:
one of the first adhesive layer and the second adhesive layer defines a greater number of adhesive areas and comprises a central adhesive area that is geometrically centered on the film layer, and
the other of the first adhesive layer and the second adhesive layer defines a smaller number of adhesive areas and comprises adhesive areas that are symmetrically arranged around the central adhesive area in at least one direction.

20. The apparatus of claim 10, wherein one or more of:
the film layer is formed of a thermoplastic resin and comprises a thickness of at least 35 mm, and
the first adhesive layer and the second adhesive layer are formed of an acrylic pressure-sensitive adhesive.
